(19) United States
(12) Patent Application Publication
(10) Pub. No.: US 2010/0079818 A1
(43) Pub. Date: Apr. 1, 2010

(54) IMAGE FORMING APPARATUS TO IMPROVE IMAGE QUALITY AND IMAGE QUALITY IMPROVEMENT METHOD

(76) Inventor: Hyeon-seok Seo, Incheon (KR)

Correspondence Address: STEIN MCEWEN, LLP, 1400 EYE STREET, NW, SUITE 300, WASHINGTON, DC, 20005, US

(21) Appl. No.: 12/426,505

(22) Filed: Apr. 20, 2009

(30) Foreign Application Priority Data
Sep. 29, 2008 (KR) 2008-95213

(51) Int. Cl. G06K 15/02

(52) U.S. Cl. 358/3.24; 358/3.27; 358/1.11

(57) ABSTRACT

An image forming apparatus to improve image quality. An image forming apparatus includes an object dividing unit to divide scanned image data into objects, an object size estimation unit to estimate a size of each object, a controlling unit to determine whether to perform image quality enhancement processing for each object according to the estimated size of the object, and an image quality enhancement unit to perform image quality enhancement processing for the objects according to the determination of the controlling unit. Therefore, when a document is printed, data having optimum quality are provided.

### CROSS-REFERENCE TO RELATED APPLICATION

This application claims the benefit of Korean Patent Application No. 2008-95213, filed on Sep. 29, 2008, in the Korean Intellectual Property Office, the disclosure of which is incorporated herein by reference.

### BACKGROUND OF THE INVENTION

1. Field of the Invention

Aspects of the present invention relate to an image forming apparatus to improve image quality and an image quality improvement method thereof, and more particularly, to an image forming apparatus to improve image quality in consideration of the size of an object and an image quality improvement method thereof.

2. Description of the Related Art

Printing systems generally include a host device to transmit commands to print data, and an image forming apparatus to perform printing operations for the print data transmitted from the host device. Such an image forming apparatus can be peripheral devices, such as a printer, a scanner, or a multi-function product.

Printing operations of such a printing system will be explained as follows. If an application program of a host device issues a command to print data, a graphics device interface (GDI) transmits information regarding the data to be printed to a driver. The driver generates print data such as text commands, image commands, or vector commands corresponding to each object using the data information transmitted from the GDI. The driver transmits the generated print data to an image forming apparatus in order that the image forming apparatus is able to perform printing operations.

These printing systems apply different methods for enhancing image quality to respective objects when performing the above printing operations. For example, in order to enhance the image quality of text data, when pixels are varied to highlight light-colored text on a dark background, the thickness of text is estimated using edge information. Therefore, even if text uses the same font, the thickness of the text differs according to its location, and thus text having the same font may be highlighted to different degrees.

If the same trapping processing is applied to each part of the text, it is not difficult to discern text having a large font, but it is difficult to discern text having a small font.

### SUMMARY OF THE INVENTION

Aspects of the present invention relate to an image forming apparatus to improve image quality and an image quality improvement method thereof, in which image quality enhancement processing is performed in consideration of the size of an object.

According to an aspect of the present invention, there is provided an image forming apparatus, including an object dividing unit to divide scanned image data into objects; an object size estimation unit to estimate a size of each object; a controlling unit to determine whether to perform image quality enhancement processing for each object according to the estimated size of the object; and an image quality enhancement unit to perform image quality enhancement processing for the objects according to the determination of the controlling unit.

According to another aspect of the present invention, the image forming apparatus may further include a storage unit to store information regarding an image quality enhancement method corresponding to the size of each object, wherein the image quality enhancement unit performs image quality enhancement processing on the object by applying an image quality enhancement method corresponding to the size of each object according to the information stored in the storage unit.

According to another aspect of the present invention, the object is text, and the object size estimation unit estimates a font size of the text.

According to another aspect of the present invention, the image quality enhancement unit may include an edge enhancement unit to perform edge enhancement processing on an edge of the text, wherein the controlling unit performs the edge enhancement processing on the text if the font size of the text is equal to or greater than a predetermined size.

According to another aspect of the present invention, the image quality enhancement unit may include a trapping processing unit to perform trapping processing on the text, wherein the controlling unit adjusts a degree of trapping processing to be performed on the text according to the font size of the text.

The image quality enhancement unit may include a trapping processing unit to perform trapping processing on the text, wherein the controlling unit performs the trapping processing on the text if the font size of the text is equal to or greater than a predetermined size.

According to another aspect of the present invention, the image quality enhancement unit may include a screening processing unit to perform a predetermined screening on the text, wherein the controlling unit performs the predetermined screen of the text if a font size of the text is equal to or greater than a predetermined size.

According to another aspect of the present invention, the image quality enhancement unit may include a property change unit to change properties of the text, wherein the controlling unit changes the properties of the text if the font size of the text is equal to or greater than a predetermined size.

According to another aspect of the present invention, the properties of the text are changed to at least one of raster and vector graphic images.

According to another aspect of the present invention, the controlling unit determines at least one of parameters and options of the image quality enhancement processing using information regarding the font size of the text estimated by the object size estimation unit.

According to another aspect of the present invention, the controlling unit performs image quality enhancement processing in a different manner for each font size using information regarding the font size of the text estimated by the object size estimation unit.

According to another aspect of the present invention, the image quality enhancement processing comprises at least one of trapping, sharpening, object based halftoning, and small font emphasis.

According to another aspect of the present invention, the object comprises at least one of text, raster, and vector graphic images.

According to another aspect of the present invention, a method for improving image quality in an image forming apparatus, the method including dividing scanned image data into objects; estimating a size of each object; determining whether to perform image quality enhancement processing for each object according to the estimated size of the object; and performing image quality enhancement processing for the objects according to the determination.

According to another aspect of the present invention, the method may further include determining information regarding an image quality enhancement method corresponding to the size of each object, wherein the performing image quality enhancement processing on the object by applying an image quality enhancement method corresponding to the size of each object according to the determined information.

According to another aspect of the present invention, the object is text, and the estimating operation estimates a font size of the text.

According to another aspect of the present invention, the performing the image quality enhancement processing may include performing edge enhancement processing on an edge of the text if a font size of the text is equal to or greater than a predetermined size.

According to another aspect of the present invention, the performing the image quality enhancement processing may include adjusting a degree of trapping processing to be performed on the text according to the font size of the text.

According to another aspect of the present invention, the performing the image quality enhancement processing may include performing the trapping processing on the text if the font size of the text is equal to or greater than a predetermined size.

According to another aspect of the present invention, the performing the image quality enhancement processing may include performing a predetermined screening on the text if the font size of the text is equal to or greater than a predetermined size.

According to another aspect of the present invention, the method may further include changing properties of the text if the font size of the text is equal to or greater than a predetermined size.

According to another aspect of the present invention, the properties of the text are changed to at least one of raster and vector graphic images.

According to another aspect of the present invention, the determining whether to perform the image quality enhancement processing may include determining at least one of parameters and options of the image quality enhancement processing using information regarding the estimated font size of the text.

According to another aspect of the present invention, the performing the image quality enhancement processing may include performing image quality enhancement processing in a different manner for each font size using information regarding the estimated font size of the text.

According to another aspect of the present invention, the image quality enhancement processing may include at least one of trapping, sharpening, object based halftoning, and small font emphasis.

According to another aspect of the present invention, the object may include at least one of text, raster, and graphic images.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings, of which:

FIG. 1 is a block diagram of an image forming apparatus 100 according to an example embodiment of the present invention;

FIG. 2 is a block diagram of an image forming apparatus 200 according to another example embodiment of the present invention;

FIG. 3 is a block diagram of an image quality enhancement unit of the image forming apparatuses in FIGS. 1 and 2;

FIGS. 4A to 4C are views provided to explain edge enhancement processing according to example embodiments of the present invention;

FIGS. 5A to 5C are views provided to explain trapping processing according to example embodiments of the present invention;

FIGS. 6A to 6C are views provided to explain the process of highlighting light-colored text on a dark background according to example embodiments of the present invention;

FIG. 7 is a flowchart of the process of improving image quality using an image forming apparatus according to an example embodiment of the present invention; and

FIG. 8 is a flowchart of the process of improving image quality using an image forming apparatus according to another example embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below, in order to explain the present invention by referring to the figures.

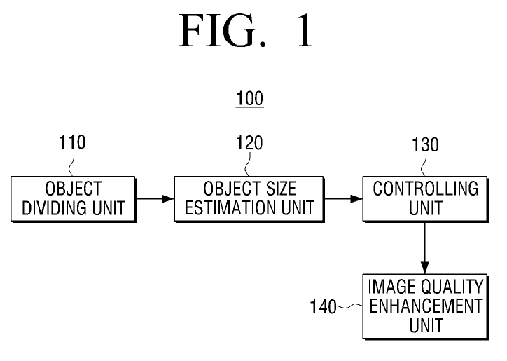

FIG. 1 is a block diagram of an image forming apparatus 100 according to an example embodiment of the present invention. Referring to FIG. 1, the image forming apparatus 100 includes an object dividing unit 110, an object size estimation unit 120, a controlling unit 130, and an image quality enhancement unit 140.

The image forming apparatus 100 scans a document and acquires digital data from the scanned document. The image forming apparatus 100 may be a copy machine, a scanner, a multi-function peripheral, or the like.

If a document containing an image is scanned and if image data containing red, green, and blue (RGB) data are generated, the object dividing unit 110 divides images contained in the RGB image data according to the properties of the data. The properties of the objects included in the image data may be text, raster, and vector graphics. That is, the object may be divided into text, raster, and vector graphics.

The object dividing unit 110 divides an image into objects of a scanned document wherein the objects have properties such as text, raster, and vector graphics using a page description language (PDL) or an object dividing algorithm, and generates information regarding the object, such as information regarding the property and size of the object.

For example, the object dividing unit 110 includes a graphics device interface (GDI) and a display driver IC (DDI). The object dividing unit 110 divides data received from an application, which generates a command for processing data according to the operating characteristics, into text, raster, and vector graphics and generates information regarding the property and size of the data.

The RGB image data divided by the object dividing unit 110 are converted into cyan, magenta, yellow, and black (CMYK) image data so that image quality enhancement processing and image halftone processing may be performed on the CMYK image data. The image quality enhancement processing and image halftone processing are performed on image data of CMYK which is a color space for printing.

The object size estimation unit 120 estimates the size of each object divided by the object dividing unit 110. The object size estimation unit 120 may estimate the size of each object using the information regarding the size of the object which is divided into text, raster, vector graphics. The size of each object may be represented in bytes, and the size of text may be represented in points (pt).

The controlling unit 130 determines parameters or options according to the size of each object estimated by the object size estimation unit 120, and enhances the quality of images corresponding to each object. The operations for enhancing the quality of images may include trapping, sharpening, edge enhancement, object-based halftoning, small font emphasizing, or the like, which will be explained below.

Specifically, the controlling unit 130 may determine the type of image quality enhancement processing and whether to perform the image quality enhancement processing with reference to a predetermined threshold value regarding the object size. The predetermined threshold value may be set differently according to the properties of the objects. For example, a threshold value of text may be a font size, and the font size may be set differently for each type of font.

In this example embodiment of the present invention, text is provided as an object. However, raster or vectors graphic may also be applicable to the example embodiment of the present invention as an object.

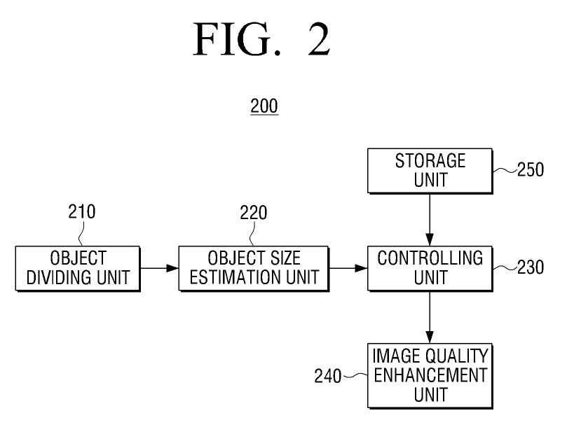

FIG. 2 is a block diagram of an image forming apparatus 200 according to another example embodiment of the present invention. Referring to FIG. 2, the image forming apparatus 200, according to the example embodiment of the present invention, includes an object dividing unit 210, an object size estimation unit 220, a controlling unit 230, an image quality enhancement unit 240, and a storage unit 250. Elements illustrated in FIG. 2, which are also found in FIG. 1, will not be explained below.

If the object size estimation unit 220 estimates the font size of each text divided by the object dividing unit 210, the controlling unit 230 performs image quality enhancement processing on the corresponding text according to the font size estimated by the object size estimation unit 220. The image quality enhancement processing may include trapping, sharpening, edge enhancement, or the like.

Trapping is an image processing method to enlarge or reduce pixels wherein one color overlaps with an adjacent color so that color is correctly applied.

Sharpening is a method for processing an image to reduce image blurring and enhance image clarity by adjusting a level of each edge pixel.

Edge enhancement is a method for processing an image to emphasize edges by enlarging or reducing pixels or changing the level of pixels since edge elements of scanned data tend to have less edge elements than original data do.

The storage unit 250 may store information regarding image quality enhancement processing set to correspond to the font size of the text.

The controlling unit 230 determines whether to apply image quality enhancement processing with reference to a predetermined threshold value regarding the size of the object in the example embodiment of the present invention shown in FIG. 1. However, the type of image quality enhancement processing and whether to apply the image quality enhancement processing to text may be determined with reference to information stored in the storage unit 250 in this example embodiment of the present invention.

The storage unit 250 may store information regarding the type of image quality enhancement processing and whether to apply the image quality enhancement processing to text. The storage unit 250 may also store information regarding the type of image quality enhancement processing to be applied for each font size and whether to apply the image quality enhancement processing to text.

For example, the storage unit 250 may store information regarding whether trapping processing is to be applied to text if the font size of the text is equal to or greater than 8 pt, or whether trapping processing and edge enhancement are to be applied to the text if the font size of a text is equal to or greater than 16 pt, or whether trapping, edge enhancement and object property changing are to be applied to the text if the font size of a text is equal to or greater than 40 pt. Alternatively, if the font size of a text is equal to or greater than 8 pt and smaller than 16 pt, the storage unit 250 may store information that trapping is applied such that one pixel overlaps, and if the font size of a text is equal to or greater than 16 pt, the storage unit 250 may store information that trapping is applied such that two pixels overlap. However, this is merely an example embodiment of the present invention. The threshold value of the font size and the image quality enhancement processing to be applied to text may vary.

The image quality enhancement unit 240 enhances image quality by applying image quality enhancement processing for each font size to each text with reference to information stored in the storage unit 250.

While the image quality enhancement processing is explained in this example embodiment of the present invention, in another example embodiment of the present invention, the halftone processing such as screening and error diffusion which are applied after the image quality enhancement processing may also be applied differently to each text according to the font size.

As the image forming apparatus 200 according to the example embodiment of the present invention represents an image at a binary level having two states according to whether dots are output or not, unlike an image device which represents an image with multiple levels, an image represented with multiple levels is converted to an image with a binary level. The process of converting a continuous tone image to a binary image is referred to as halftone processing.

The method for performing halftoning includes error diffusion, dithering, or the like, but these are well known to those skilled in the art. Therefore, halftone processing will be explained briefly in this example embodiment of the present invention.

Halftone screening is performed by comparing gradation values ranging from 0 to 255 to be converted to binary values with a predetermined screen and converting the gradation values to binary values.

A screen may be divided into amplitude modulated (AM) screens and frequency modulated (FM) screens according to a method for forming dots. As dots are output on an AM screen in cluster, the dots are output more stably than an FM screen having dense dots. Thus, the AM screen is also referred to as a cluster screen. Because of the characteristics of reproducibility of an AM screen, an image is reproduced smoothly at low line per inch (LPI) values, but it is difficult to reproduce the image in detail. On the other hand, an image is reproduced in detail at a high LPI values, but it is difficult to reproduce an image smoothly.

Screening is appropriately applied to each text according to the font size of text by adjusting the parameters to be applied to the screening, the number of dots, and the density of dots in this example embodiment of the present invention.

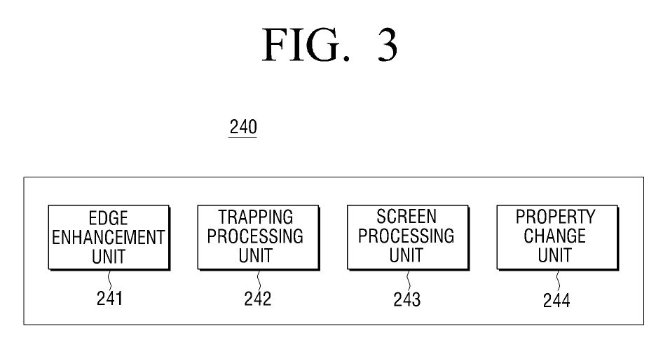

FIG. 3 is a block diagram of the image quality enhancement unit of the image forming apparatuses in FIGS. 1 and 2. Referring to FIG. 3, the image quality enhancement unit 240 includes an edge enhancement unit 241, a trapping processing unit 242, a screen processing unit 243, and a property change unit 244.

The edge enhancement unit 241 enhances an edge of the text if the object size estimation unit 220 determines that the font size of the text is equal to or greater than a predetermined font size. If edge enhancement processing is performed on text having a small font size, the gray level of the text varies so significantly that defects may occur in the text and may render the text difficult to read. Accordingly, if the object size estimation unit 220 determines that the font size of the text is smaller than a predetermined font size, edge enhancement processing is not performed or the degree of edge enhancement is adjusted.

The edge enhancement processing may be performed using various methods. For example, in the method for enhancing an edge in digital image data converted from analog image data, a window of an appropriate size, such as 3×3 or 5×5, is assigned to pixels having a current pixel to acquire image data on which an edge enhancement is applied.

When pixels of light-colored text on a dark background are changed in order to make the light-colored text clearer, edge enhancement is performed using information regarding the font size of text instead of edge information, which is used in related art. If edge information is considered, the text is enhanced to different degrees since the thickness of text differs according to the location. However, if only the font size is considered, the outline of the text having the same font size is enhanced to the same degree so that image quality improves.

The trapping processing unit 242 performs trapping processing to prevent white space from occurring between text and graphics. In this situation, if trapping processing is performed on text having a small font size, defects may occur in the text. For example, readability of the text is reduced because the size of the text varies significantly. Accordingly, the trapping processing is performed on text having a font size equal to or greater than a predetermined font size.

The trapping processing unit 242 adjusts the degree of the trapping processing to be performed on text having a font size smaller than a predetermined font size under the control of the controlling unit 230.

For example, trapping processing is performed only when text has a font size equal to or greater than 8 pt. However, if a font size is equal to or greater than 8 pt, one pixel overlaps and if a font size is equal to or greater than 16 pt, two pixels overlap.

The screen processing unit 243 may apply the type and degree of screen to the text differently according to the font size of the text under the control of the controlling unit 230.

For example, if it is determined that the font size of the text is equal to or greater than 8 pt, type A screen processing is performed on the text, and if it is determined that the font size of the text is smaller than 8 pt, type B screen processing is performed on the text. Even though the same type of screen processing is performed on each text, screen processing may be performed appropriately on the text by adjusting the parameters, options, or the like to be applied to the screen processing.

Screen processing may generally be included in the halftone processing operation instead of in the image quality enhancement processing operation. However, the screen processing unit 243 is included in the image quality enhancement unit 240 in this example embodiment of the present invention for convenience of description.

The property change unit 244 may adjust properties of text according to the font size of the text. For example, when the image quality enhancement processing is performed on text having a font size greater than 40 pt, the properties of the text are changed to graphic or raster properties and thus image quality enhancement processing corresponding to graphic or raster properties may be performed on the text.

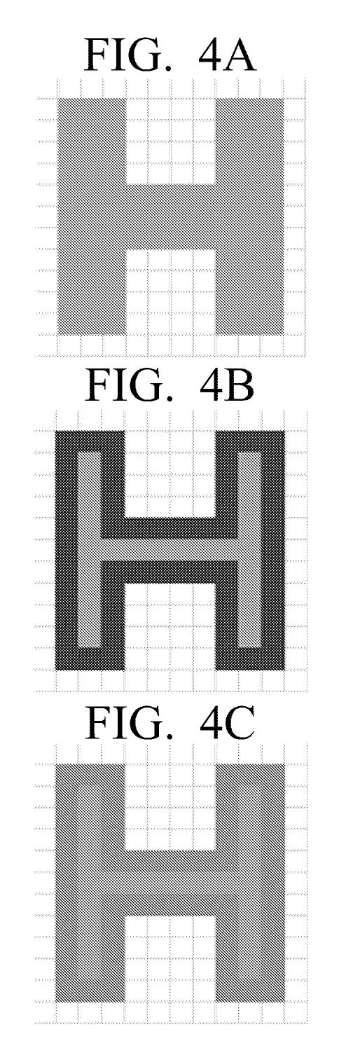

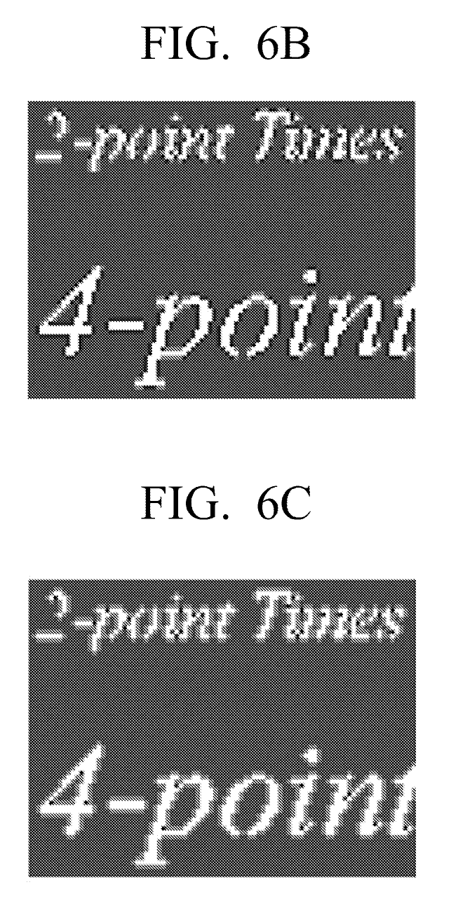

A method for processing image quality enhancement according to an example embodiment of the present invention will be explained in detail with reference to FIGS. 4 and 6.

FIGS. 4A to 4C are views provided to explain edge enhancement processing according to example embodiments of the present invention.

FIG. 4A shows an original image, FIG. 4B shows an image on which edge enhancement processing is performed on text having a font size equal to or greater than a predetermined font size, and FIG. 4C shows an image on which edge enhancement processing is performed on text having a font size smaller than the predetermined font size.

Referring to FIG. 4B, if edge enhancement processing is performed on text having a font size equal to or greater than a predetermined font size, significant defects do not occur in the text since the gray level of the text varies slightly even if the degree of edge enhancement is high.

However, referring to FIG. 4C, if edge enhancement processing is performed on the text having a font size smaller than a predetermined font size, defects occur in the text, for example, readability of the text is reduced because the gray level of the text varies significantly. Accordingly, when edge enhancement processing is performed on text having a font size smaller than a predetermined font size, edge enhancement processing is not performed on the text or the degree of edge enhancement is reduced so that defects in the text are minimized.

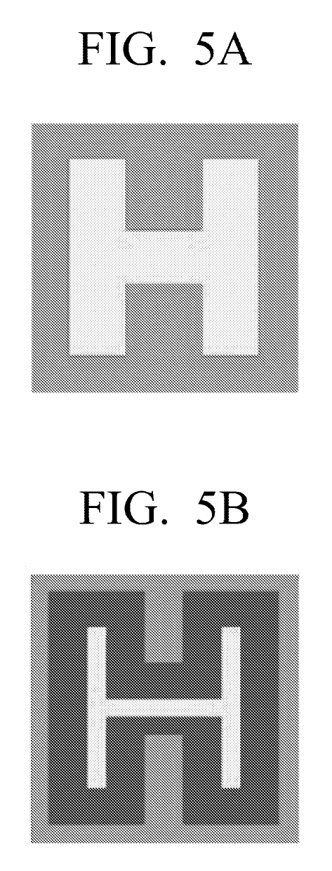

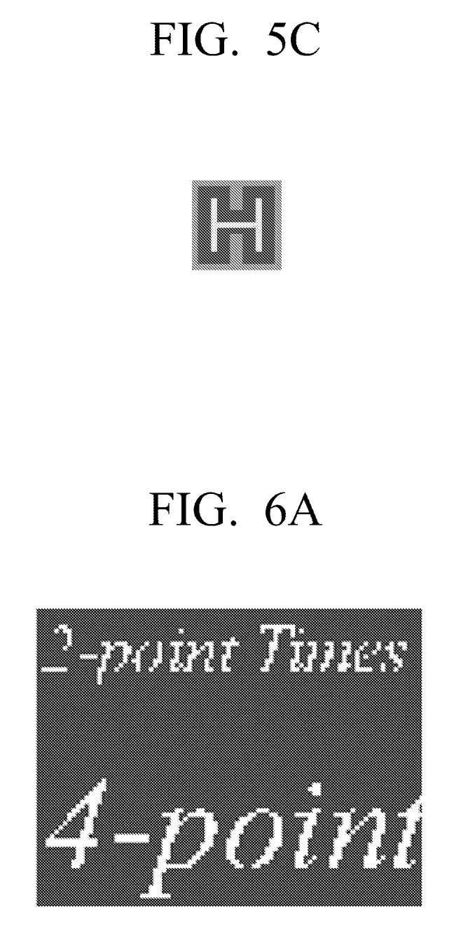

FIGS. 5A to 5C are views provided to explain trapping processing according to example embodiments of the present invention.

FIG. 5A shows an original image, and FIG. 5B shows an image on which trapping processing is performed on text having a font size equal to or greater than a predetermined font size.

Referring to FIG. 5B, if trapping processing is performed on text having a font size equal to or greater than a predetermined font size, significant defects do not occur in the text since the size of the text varies slightly.

However, referring to FIG. 5C, if trapping processing is performed on text having a font size smaller than a predetermined font size in the same manner as trapping processing is performed on the larger text, defect occur on the text, such as the font size of the text varying significantly. Accordingly, trapping processing is not performed on text having a font size smaller than a predetermined font size, or trapping processing is performed on the text to a low degree so that defects of the text are minimized.

FIGS. 6A to 6C are views provided to explain the process of highlighting light-colored text on a dark background according to example embodiments of the present invention.

FIG. 6A shows an original image, FIG. 6B shows an image on which text is enhanced using edge information, and FIG. 6C shows an image on which text is enhanced according to the font size of the text.

Referring to FIG. 6B, the thickness of the text is estimated using edge information, and the text is enhanced according to the thickness of the text. In this situation, as each portion of the text varies in thickness, defects occur in the text because the degree of enhancement of the text varies.

However, referring to FIG. 6C, if the text is enhanced according to the font size of the text only, outline of text having the same font size is highlighted to the same degree so that image quality is improved. Accordingly, defects occurring in text may be minimized by performing image quality enhancement processing on the text according to the font size of the text instead of the edge information of the text to enhance a light-colored text on a dark background.

According to FIGS. 4 to 6, the quality of text may be improved when printing an image.

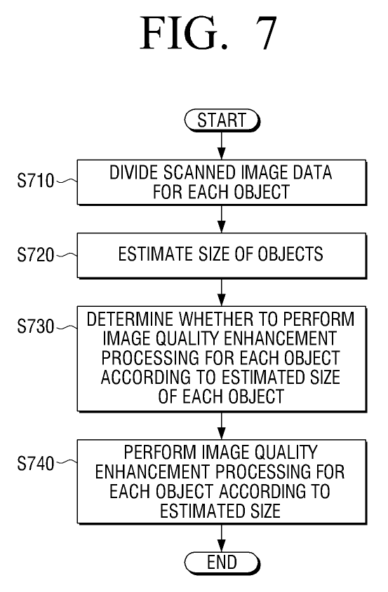

FIG. 7 is a flowchart of the process of improving image quality using an image forming apparatus according to an example embodiment of the present invention. As shown in FIG. 7, scanned image data are separated for each object at block S710. The object may be divided into text, raster, and vector graphics according to the properties of the image.

The object dividing unit 110, as shown, for example, in FIG. 1, uses a page description language (PDL) or object dividing algorithms in order to divide an object of a scanned document into text, image, and vector graphics and generate related information.

The size of the objects divided at block S710 is estimated at block S720 using information regarding the object size generated at block S710. The object size estimation unit 120 estimates the size of the object.

Next, the controlling unit 130 determines whether to perform image quality enhancement processing for each object according to the estimated size of each object at block S730. The image quality enhancement processing is performed for each object according to the estimated size at block S740. The image quality enhancement processing may include trapping, sharpening, and edge enhancement.

Specifically, whether to perform image quality enhancement processing may be determined based on a predetermined threshold value according to the size of the object. The predetermined threshold value may be set according to the properties of object. For example, if an object is text, the font size of the text is estimated and whether to perform image quality enhancement processing and the type of image quality enhancement processing to be performed may be determined according to the estimated font size of the text.

Hereinbelow, a text object will be explained as an example embodiment of the present invention for convenience of description. However, the example embodiment may also be applied to various objects such as raster or graphics.

Whether to perform edge enhancement processing and the degree of edge enhancement processing to be performed may be determined at block S730. For example, if the font size of the text is equal to or greater than 8 pt, it may be determined that the edge enhancement processing is performed.

At block S740, the edge enhancement processing is performed on text having a font size equal to or greater than 8 pt according to the degree of edge enhancement processing determined at block S730.

Whether to perform trapping processing and the degree of trapping processing performed may be determined according to the font size of text at block S730. For example, if the font size of text is equal to or greater than 8 pt, the trapping processing is performed. However, if the font size of text is equal to or greater than 16 pt, the trapping processing is performed on two pixels of text, and if the font size of text is equal to or greater than 8 pt, the trapping processing is performed on one pixel of text.

The trapping processing for text having a font size equal to or greater than 8 pt may be performed at block S740 according to the font size determined at block S730.

Whether to perform screen processing and the type and degree of screen processing performed may be determined according to the font size of the text at block S730. For example, if it is determined that the font size of text is equal to or greater than 8 pt, type A screen processing may be performed on the text, and if it is determined that the font size of text is smaller than 8 pt, type B screen processing may be performed on the text.

The screen processing may be performed at block S740 according to the font size of the text determined at block S730.

Whether to change properties of the text may be determined according to the font size of the text at block S730. For example, if it is determined that the font size of text is equal to or greater than 40 pt, the text may be treated as raster or vector graphic instead of text.

The image quality enhancement processing corresponding to properties of raster graphics may be performed at block S740 according to the font size determined at block S730.

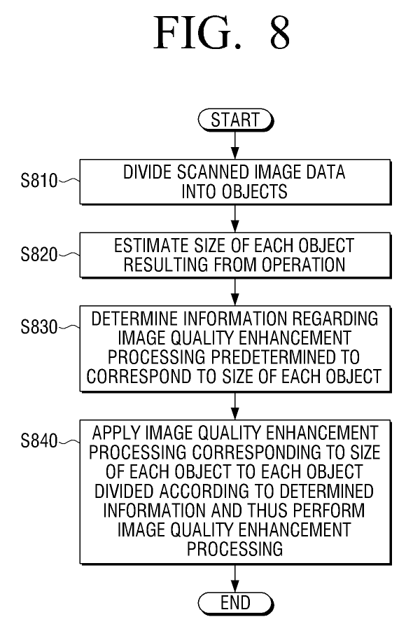

FIG. 8 is a flowchart of the process of improving image quality using an image forming apparatus according to another example embodiment of the present invention.

Referring to FIG. 8, scanned image data are divided into objects at block S810. The objects may include text, raster, and vector graphics.

In the object dividing processing, a PDL or an object dividing algorithm are used to divide an object of a scanned document into text, image, and vector graphics and to generate information regarding the object.

The size of each object resulting from block S810 is estimated at block S820 using information regarding the object size generated at block S810.

Information regarding the image quality enhancement processing predetermined to correspond to the size of each object is determined at block S830. The image quality enhancement processing corresponding to the size of each object is applied to each object according to the determined information and thus image quality enhancement processing is performed at block S840.

For example, if it is determined that an object is text, the font size of the text is classified into various degrees and the image quality enhancement processing predetermined to correspond to each range may be stored. The image quality enhancement processing is performed using the stored information regarding the image quality enhancement processing corresponding to each range at block S840.

As described above, according to the example embodiments of the present invention, a threshold value of the size of object and the type and degree of image quality enhancement processing are predetermined according to the size of object. However, the above information may be changed by a user through a user interface according to another example embodiment.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An image forming apparatus, comprising:
an object dividing unit to divide scanned image data into objects;
an object size estimation unit to estimate a size of each object;
a controlling unit to determine whether to perform image quality enhancement processing for each object according to the estimated size of the object; and
an image quality enhancement unit to perform image quality enhancement processing for the objects according to the determination of the controlling unit.

2. The image forming apparatus according to claim 1, further comprising:
a storage unit to store information regarding an image quality enhancement method corresponding to the size of each object,
wherein the image quality enhancement unit performs image quality enhancement processing on the object by applying an image quality enhancement method corresponding to the size of each object according to the information stored in the storage unit.

3. The image forming apparatus according to claim 1, wherein the object is text, and the object size estimation unit estimates a font size of the text.

4. The image forming apparatus according to claim 3, wherein the image quality enhancement unit comprises:
an edge enhancement unit to perform edge enhancement processing on an edge of the text,
wherein the controlling unit performs the edge enhancement processing on the text if a font size of the text is equal to or greater than a predetermined size.

5. The image forming apparatus according to claim 3, wherein the image quality enhancement unit comprises:
a trapping processing unit to perform trapping processing on the text,
wherein the controlling unit adjusts a degree of trapping processing to be performed on the text according to the font size of the text.

6. The image forming apparatus according to claim 5, wherein the image quality enhancement unit comprises:
a trapping processing unit to perform trapping processing on the text,
wherein the controlling unit performs the trapping processing on the text if the font size of the text is equal to or greater than a predetermined size.

7. The image forming apparatus according to claim 3, wherein the image quality enhancement unit comprises:
a screening processing unit to perform a predetermined screening on the text,
wherein the controlling unit performs the predetermined screening on the text if the font size of the text is equal to or greater than a predetermined size.

8. The image forming apparatus according to claim 3, wherein the image quality enhancement unit comprises:
a property change unit to change properties of the text,
wherein the controlling unit changes the properties of the text if the font size of the text is equal to or greater than a predetermined size.

9. The image forming apparatus according to claim 8, wherein the properties of the text are changed to at least one of raster and vector graphic images.

10. The image forming apparatus according to claim 3, wherein the controlling unit determines at least one of parameters and options of the image quality enhancement processing using information regarding the font size of the text estimated by the object size estimation unit.

11. The image forming apparatus according to claim 3, wherein the controlling unit performs image quality enhancement processing in a different manner for each font size using information regarding the font size of the text estimated by the object size estimation unit.

12. The image forming apparatus according to claim 1, wherein the image quality enhancement processing comprises at least one of trapping, sharpening, object based halftoning, and small font emphasis.

13. The image forming apparatus according to claim 1, wherein the object comprises at least one of text, raster, and vector graphic images.

14. A method for improving image quality in an image forming apparatus, the method comprising:
dividing scanned image data into objects;
estimating a size of each object;
determining whether to perform image quality enhancement processing for each object according to the estimated size of the object; and
performing image quality enhancement processing for the objects according to the determination.

15. The method according to claim 14, further comprising:
determining information regarding an image quality enhancement method corresponding to the size of each object,
wherein the performing image quality enhancement processing on the object by applying an image quality enhancement method corresponding to the size of each object according to the determined information.

16. The method according to claim 14, wherein the object is text, and the estimating operation estimates a font size of the text.

17. The method according to claim 16, wherein the performing the image quality enhancement processing comprises:
performing edge enhancement processing on an edge of the text if a font size of the text is equal to or greater than a predetermined size.

18. The method according to claim 16, wherein the performing the image quality enhancement processing comprises:
adjusting a degree of trapping processing to be performed on the text according to the font size of the text.

19. The method according to claim 18, wherein the performing the image quality enhancement processing comprises:
performing the trapping processing on the text if the font size of the text is equal to or greater than a predetermined size.

20. The method according to claim 16, wherein the performing the image quality enhancement processing comprises:
performing a predetermined screening on the text if the font size of the text is equal to or greater than a predetermined size.

21. The method according to claim 16, further comprising:
changing properties of the text if the font size of the text is equal to or greater than a predetermined size.

22. The method according to claim 21, wherein the properties of the text are changed to at least one of raster and vector graphic images.

23. The method according to claim 16, wherein the determining whether to perform the image quality enhancement processing comprises:
determining at least one of parameters and options of the image quality enhancement processing using information regarding the estimated font size of the text.

24. The method according to claim 16, wherein the performing the image quality enhancement processing comprises:
performing image quality enhancement processing in a different manner for each font size using information regarding the estimated font size of the text.

25. The method according to claim 14, wherein the image quality enhancement processing comprises at least one of trapping, sharpening, object based halftoning, and small font emphasis.

26. The method according to claim 14, wherein the object comprises at least one of text, raster, and graphic images.
